(19) United States
(12) Patent Application Publication
(10) Pub. No.: US 2010/0060230 A1
(43) Pub. Date: Mar. 11, 2010

(54) Mobile Chargers for Charging Secondary Batteries From Secondary Batteries

(75) Inventors: Herbert Schein, Munningen (DE); Michael Kron, Lebach (DE); Dejan Ilic, Ellwangen (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: VARTA MICROBATTERY GMBH, A CORPORATION OF GERMANY, HANNOVER (DE)

(21) Appl. No.: 11/989,719

(22) PCT Filed: Aug. 2, 2006
(86) PCT No.: PCT/EP2006/007625

§ 371 Date: Aug. 18, 2009

(30) Foreign Application Priority Data
Aug. 5, 2005 (DE) 10-2005-039-083.8
Apr. 7, 2006 (DE) 10-2006-017-997.8

(51) Int. Cl. H02J 7/00

(52) U.S. Cl. 320/103

(57) ABSTRACT

A mobile charger including a connector that facilitates charging at least one first battery from at least one second battery, wherein the second battery is a secondary battery and the second battery has a higher capacity than the first battery, thus allowing the first battery to be charged more than once; and a method for charging at least one first battery from at least one second battery, including connecting the second battery to the first battery with a secondary battery being used as the second battery to charge the at least one first battery, which secondary battery has a higher capacity than the first battery such that the first battery can be charged more than once.

### RELATED APPLICATIONS

This is a §371 of International Application No. PCT/EP2006/007625, with an international filing date of Aug. 2, 2006 (WO 2007/017165 A2, published Feb. 15, 2007), which is based on German Patent Application Nos. DE 10 2005 039 083.8, filed Aug. 5, 2005, and DE 10 2006 017 997.8, filed Apr. 7, 2006.

### TECHNICAL FIELD

This disclosure relates to mobile chargers for charging at least one first battery from at least one second battery, and to corresponding methods.

### BACKGROUND

Chargers, that is to say apparatuses for charging rechargeable batteries (secondary batteries, accumulators) are already known in widely differing embodiments. Such chargers are normally provided in a fixed position and accordingly to be supplied with mains voltage from the electrical mains system. Such fixed-position chargers are generally in the form of table top appliances or plug-in power supply units. The fact that the fixed-position chargers have to be connected to the electrical mains system during operation makes such chargers inflexible. Furthermore, normally, they cannot easily be transported, because of their dimensions. Chargers such as these accordingly normally remain at a specific location, for example, the user's dwelling or place of work.

To reduce the disadvantages of fixed-position chargers, chargers have already been developed which draw their charging energy from other sources. For example, car batteries are frequently used as an energy source, although appropriate connections or connecting appliances are required for this purpose.

Chargers also exist which charge secondary batteries with the electricity produced by solar cells. Such appliances require sufficient light for smooth operation, of course, so that long charging times frequently have to be accepted. Furthermore, such appliances are also frequently comparatively cumbersome because of the size of solar cells at the moment.

On the other hand, however, there is a major requirement to use rechargeable batteries and to be able to recharge them both quickly and independently of fixed-position chargers, particularly for certain applications. This problem occurs, in particular, with hearing aids, since such appliances consume a comparatively large number of batteries. Because of the dimensions of hearing aids, only comparatively small batteries can be used, generally so-called “button cells,” which are discharged quickly during continuous operation of hearing aids. When the button cells have been discharged, they must immediately be replaced by new cells or rechargeable cells to provide an adequate hearing capability immediately for the hearing-aid user. Because of the high consumption of batteries for hearing aids, there is a clear trend to use rechargeable batteries, that is to say secondary batteries. However, because they are discharged comparatively quickly and therefore require frequent recharging, it has not yet been possible to use so-called “nickel metal-hydride” batteries for such applications.

It could therefore be advantageous to provide chargers which allow rapid charging without connection to an electrical mains system. It could particularly be advantageous to allow button cells, in particular, of the nickel metal-hydride type, to be charged by means of the new chargers.

### SUMMARY

We provide a mobile charger including a connector that facilitates charging at least one first battery from at least one second battery, wherein the second battery is a secondary battery and the secondary battery has a higher capacity than the first battery, thus allowing the first battery to be charged more than once.

We also provide a method for charging at least one first battery from at least one second battery, including connecting the second battery to the first battery, with a secondary battery being used as the second battery to charge the at least one first battery, which secondary battery has a higher capacity than the first battery such that the first battery can be charged more than once.

### BRIEF DESCRIPTION OF THE DRAWINGS

Further features will become evident from the following description of selected representative structures in conjunction with the drawings. Individual features/aspects can each be implemented in their own right or combined with one another in groups of two or more. The described structures are intended to be used only for explanation and for better understanding, and should in no way be regarded as being restrictive.

In the drawings:

FIG. 1 is a schematic view of an arrangement of components for a charger;

FIG. 2 is a schematic perspective view of one structure of the charger;

FIG. 3 is a schematic plan view of the charger shown in FIG. 2, in a partially open state; and

FIG. 4 is a schematic view of a further structure of the charger, in the form of a cross section.

### DETAILED DESCRIPTION

The chargers are designed such that at least one second secondary battery is provided to charge the at least one first (secondary) battery. This second battery has a higher capacity than the first battery, so that the first battery can be charged from the second battery more than once.

The expression “mobile” is intended to mean that the charger, can easily be moved from one location to another, allowing rapid charging of the first battery even without connecting the charger to an electrical mains system. This allows the charger to be taken on journeys without any difficulties.

The capacity of the second battery, which is a secondary battery, may be chosen such that the first battery can be charged at least 10 times, and preferably at least 25 times, without the second battery itself having to be recharged. This measure ensures a further improvement in the mobile usage capability of the charger.

In principle, all possible first (secondary) batteries can be provided. In particular, however, the first batteries are button cells. This expression is used because these cells are similar to a button, because of their flat, generally round shape. Such button cells are available in widely differing sizes and thicknesses, and they are normally used in small appliances such as wrist watches, hearing aids, pocket computers, photographic apparatuses and the like.

The first batteries are thus preferably button cells for hearing aids.

Widely differing battery types may be used as first batteries. The first batteries are preferably so-called “nickel metal-hydride” batteries or rechargeable batteries. The electrochemical reactions on which this type of battery is based, as well as their characteristics, are familiar to those skilled in the art.

Nickel metal-hydride batteries that are used as button cells for hearing aids generally have capacities of less than 100 mAh, in particular, less than 50 mAh.

Widely differing types of secondary batteries can likewise be used as second batteries. These are preferably so-called “lithium secondary” batteries in which lithium is used as the active material in the cathode. So-called “lithium polymer secondary” batteries are particularly preferable, in which a polymer electrolyte is used. These battery types are also known to those skilled in the art.

By way of example, a lithium polymer battery with a voltage of about 3.7 V and a capacity of about 1000 mAh can preferably be used.

Our chargers may have a (common) housing in which both the at least one first battery and the at least one second battery are arranged or can be arranged. This results in the overall charger forming a common unit with the first and the second batteries, thus making it easier to handle because of this compact arrangement.

In forms with a common housing, separate holders for the first batteries and the second batteries can be provided within the housing. This has the advantage that the first batteries and the second batteries can be replaced better, independently of one another. Thus, a separate holder (battery compartment) is preferably provided in the housing for each individual first battery and/or for each individual second battery.

At least two first batteries and at least one second battery may be arranged or can be arranged in the housing. In particular, two first batteries and one second battery may be provided in the housing.

The number of first batteries which can be recharged together with one another (or depending on the circuitry possibly also separately from one another) can be matched to the number of second batteries used for charging. In particular, this ratio of the number of first batteries to the number of second batteries can be matched to one another such that the second batteries have sufficient capacity to charge the desired number of first batteries. In this case, the respective dimensions of the first batteries (preferably button cells) and of the second batteries (preferably lithium cells) can be taken into account, thus resulting, overall, in a space-saving charger design that is compact.

The above-mentioned conditions are satisfied in particular by chargers in which at least two first batteries, preferably two and only two first batteries, for example, button cells, are charged with the aid of one lithium cell. This is explained in more detail later, in conjunction with the description of the figures.

It is also preferable for the at least one second battery to be installed/fixed in the housing. This means that this second battery is not intended to be replaced. The fixed installation in the charger, in particular in the housing of the charger, simplifies its design and handling.

The charger may at least one so-called “charging circuit” which is intended in particular for selection and/or for monitoring of parameters of the charging process of the first batteries and/or of the second batteries. In particular, this charging circuit has at least one charging monitoring electronic means.

The charging circuit, in particular the charging monitoring electronic means that may be provided, makes it possible to select and control parameters such as the charging voltage, the charging current and their profiles during the charging process, both for the first batteries and for the second batteries. One further important parameter which, for example, can be selected and monitored with the aid of such charging circuits is also the charging time, that is to say the time period during which the first or second batteries are charged.

The corresponding charging circuits may, for example, be separately associated with the first or second batteries. However, they are preferably separate components which are either jointly associated with the first and second batteries or are separately associated with the first batteries and the second batteries. Separate holders can preferably be provided in the housing for the charging circuit, in particular, with a charging monitoring electronic means. This allows accommodation separately from the other components and makes it easier to replace such charging circuits.

The described charging circuit, preferably with a charging monitoring electronic means, can preferably be designed such that it is possible to select and/or change between different types of charging (charging modes). For example, it is possible to carry out rapid charging with a comparatively high charging current. This is particularly advantageous when a rechargeable first battery is intended to be made available again as quickly as possible. In a situation when more time is available for charging, for example, overnight, a charging mode can be provided in which the first battery is charged more conservatively with a comparatively low charging current.

As already mentioned, the charging circuit can also be designed such that the charging current is limited to reliably prevent excessively high charging currents which could damage the first batteries. Furthermore, the charging circuit can automatically end the charging process. This can be done, for example, by monitoring when a specific, preselected voltage is reached across the first battery to be charged. It is also possible to terminate the charging process after a specific, preselected time, in particular with the aid of a so-called “timer function” for a charging monitoring electronic means that may be provided.

To further enhance the convenience for using the charger, a switch can be provided to disconnect the first battery to be charged from the second battery. In this case, the switch disconnection contact which is required may be located as close as possible to one of the (first or second) batteries. This disconnection contact is preferably located as close as possible to one pole of a battery, in particular, to its positive pole, preferably to the positive pole of the at least one second battery, so that the second batteries, which are intended to be charged, can be disconnected directly. After disconnection by means of the switch, the second battery cannot be discharged any further so that its (remaining) capacity is largely maintained. The advantage of disconnection by the switch is also appropriate for the first batteries to be charged or which have been charged, so that they are not discharged again autonomously, after being charged.

A charging circuit can be specifically designed for those situations in which the at least one first battery is intended to remain in the charger over a relatively long time period, preferably after it has been charged. In situations such as these, the charging circuit can continuously monitor the state of the first batteries that have already been charged. If these have become partially discharged again, in particular, after remaining in the charger for a relatively long time, a charging circuit can automatically initiate recharging of the first batteries again. This ensures that there is always at least one fully charged first battery in the charger, which can be removed for use at any time.

If it is intended to leave the first battery in the charger for a relatively long time, the charging circuit can also be designed such that the charging process starts only after a specific time. If required, this time may be selected by the user in accordance with need. Charged first batteries are then available to the user in accordance with need. Undesirable discharging of first batteries that have already been charged can be prevented in this way.

In particular, to improve the convenience of use, at least one indication means/indicator, in particular at least one visual indication means, can be provided for the charger. In particular, this indication means provides the user with information about at least one operating state of the charger, in particular, about the state of charge of the first batteries and/or of the second batteries. In this case, the indication means may preferably be a light indication, in particular, in the form of at least one light-emitting diode (LED). Suitable displays or the like can also be provided as the indication means.

By way of example, the indicator for the first battery represent a state of charge “charging/charge” and “charging complete/battery full.” By way of example, these states may be represented by different-colored or multi-colored LEDs, preferably with a green color indicating the state “charging complete/battery full” and a yellow color indicating the state “charging/charged.”

Appropriate indication means can also be provided in a comparable manner for the second battery, for example, representing the states “charging battery full,” “charging battery empty” and “charging battery being charged.” In this case as well, different-colored or multi-colored LEDs can be used, in which case a green color is used to indicate the state “charging battery full,” a red color to indicate the state “charging battery empty” and a yellow color to indicate the state “charging battery being charged.” In this case, the state “charging battery full” can be indicated when the charge in the charging battery is or has reached more than a specific percentage of the rated capacity, for example 20%. Below this percentage of the rated capacity, the state of charge “charging battery empty” is then indicated. The state “charging battery being charged” is indicated when the second (secondary) battery is being charged from an external energy source, preferably from an electrical mains system.

The charger furthermore generally has at least one electrical connection, in particular, in the form of a socket, by means of which the second battery, which is in the form of a secondary battery, can itself be charged. A supply voltage of 12 V is generally applied to the charger for this purpose via this connection. This voltage can be provided by an external power supply unit or by some other suitable adapter, for example, a car battery.

Preferred structures of the charger advantageously have dimensions such that the height of the charger is small in comparison to its length and width. The charger is therefore particularly “flat.” This allows the first and second batteries, and further components which may be provided, to be arranged in a particularly space-saving manner in the charger. A compact, space-saving design such as this further improves the capability to use the charger in a mobile form.

In a corresponding manner to the statements made above with respect to the dimensions of the charger, this charger preferably has dimensions which are comparable with the dimensions of a check card, such as that generally issued by banks. Many other passes, membership cards and the like also now have the same dimensions as such check cards. In a corresponding manner, the corresponding charger can then also be stored in the receptacles, such as wallets, purses and the like, in which the user of corresponding first batteries also keeps other check cards and the like.

If the dimensions of the charger are comparable with the dimensions of a check card, then its length L is preferably less than 150 mm, in particular, less than 100 mm. In this case, furthermore, lengths L between 70 and 100 mm are preferable. In a corresponding manner, the width B of such chargers is then preferably less than 100 mm, in particular, less than 60 mm. In this case, furthermore, widths B of between 40 and 60 mm are then preferable. The height H of the chargers with the lengths L and widths B as stated above is then preferably less than 15 mm, in particular, less than 12 mm. In this case, furthermore, heights of between 8 and 10 mm are preferable.

L.B.H values of about 85 mm.about 55 mm.about 10 mm or about 85 mm.about 52 mm.about 8 mm may be quoted as particularly preferred examples for dimensions of a charger in a check-card format.

A housing provided for the charger may be designed in widely differing ways. Thus, the housing is preferably formed from a housing lower part and a housing cover part. In this case, the housing lower part is preferably in the form of a trough, so that appropriate components such as first batteries, second batteries, charging circuits and the like, can easily be accommodated in the housing lower part, in particular, in holders or compartments.

The housing cover part may be connected to the housing lower part in many different ways in which case, of course, it can be folded up or removed from the housing lower part reversibly, for opening. This can be achieved, for example, by appropriate hinges and closing mechanisms.

The housing cover part is preferably designed such that it can be moved with respect to the lower part to open the charger, for example, in the form of a sliding flap. This measure allows the charger to be opened particularly easily without having to completely disconnect the cover part from the lower part. In situations such as these, the first batteries, which are replaced frequently, can be arranged in the housing such that the cover part need be moved only over a short distance with respect to the lower part in order to make the corresponding holders for the first batteries accessible to the user.

In addition to the mobile charger, we also provide methods for charging at least one first (secondary) battery from at least one second battery. In one case, the process is for at least one secondary battery likewise to be used for charging the at least one first battery, with this second battery having a higher capacity than the first battery, thus allowing the first battery to be charged more than once.

With regard to the described and further features of the methods, reference is made expressly to the above description relating to the chargers. To this extent, the disclosure content in the description relating to the chargers also applies to the disclosure content of the description of the methods.

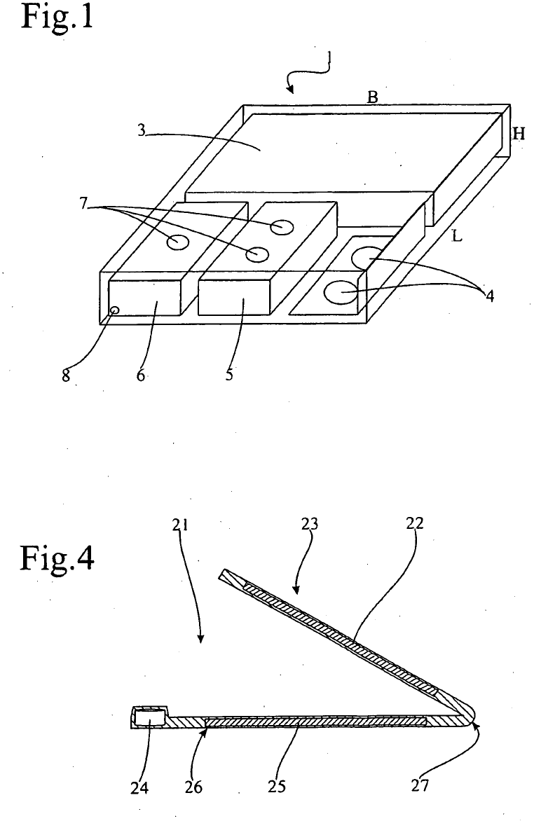

Turning now to the Drawings, FIG. 1 schematically illustrates the components (most important parts) of a charger 1. A second battery 3 (e.g., rechargeable lithium polymer battery) is provided within a housing 2, which is only indicated in the drawing. In this case, the second battery 3 is intended to be installed fixed in the housing 2.

Furthermore, the housing 2 has two holders 4 (in the form of a charging compartment) for two first batteries (e.g., rechargeable button cells), which are not illustrated in FIG. 1.

Two charging circuits 5 and 6 (e.g., each with integrated charging electronics) are provided in the housing 2. In this case, the charging circuit 5 is used to monitor the charging process of the first batteries, and the charging circuit 6 is used to monitor the charging process of the second battery 3. Indication means/indicators in the form of LEDs 7 are fitted both to the charging circuit 5 and to the charging circuit 6 and represent the states of charge of the first batteries and of the second battery.

The charging circuit 6 has an associated connecting circuit 8 by means of which the second battery 3 can be recharged, for example, by an external power supply unit or an adaptor for a car battery.

The dimensions of the charger 1 that is illustrated schematically in FIG. 1 have been chosen such that they correspond essentially to the dimensions of a check card. In a corresponding manner, the dimensions of the housing 2 and of the components contained in it are matched to one another such that the length L of the charger 1 is at most about 100 mm, its width B is at most about 60 mm, and its height H is at most about 10 mm.

FIG. 2 shows a schematic perspective view of one structure of a charger 11. This charger 11 has a housing 12 which comprises a housing lower part 13 and a housing cover part 14. The housing lower part is in the form of a trough in which the individual functional components of the charger 11 are accommodated. Indication means in the form of LEDs 15 and 16 are provided on the housing lower part 13, with the LEDs 15 being used to indicate the state of charge of the first batteries, which are not illustrated in FIG. 2, and with the LEDs 16 being used to indicate the state of charge of the second battery, which is not illustrated in FIG. 2.

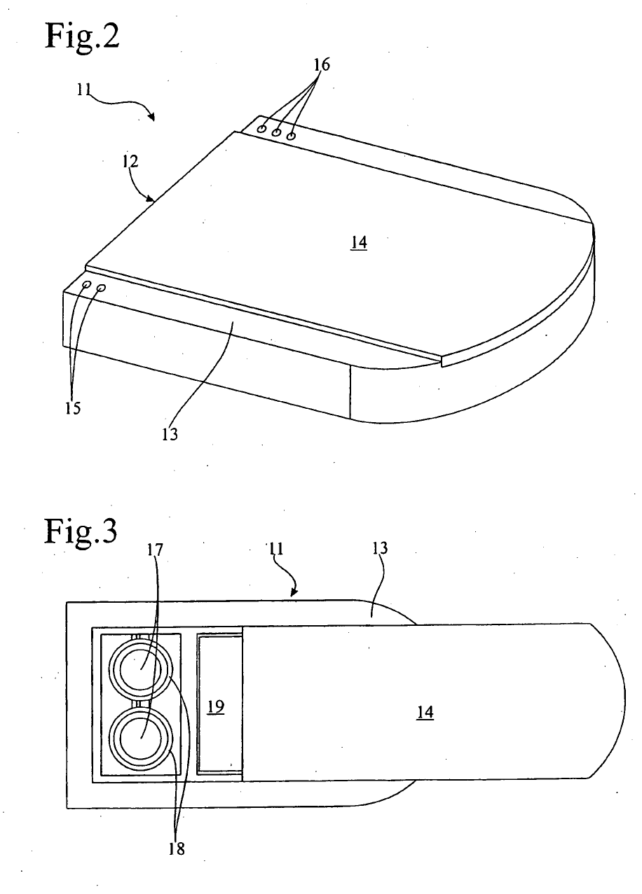

The housing cover part 14 can be moved with respect to the housing lower part 13 to open the charger 11, as will be explained in more detail in conjunction with FIG. 3.

FIG. 3 shows a schematic plan view of the charger 11, as shown in FIG. 2, in the partially open state. Accordingly, the housing cover part 14 has been moved with respect to the housing part 13 such that the interior of the charger 11 is (at least partially) accessible. The LEDs 15, 16 illustrated in FIG. 2 are not shown in FIG. 3, for clarity reasons.

Because the charger 11 is in the partially open state in FIG. 3, it is possible to see two first batteries 17 (rechargeable button cells) which are located in their associated holders (battery compartments) 18. FIG. 3 also shows a second battery 19 (rechargeable lithium polymer battery) which is used for charging the two first batteries 17.

The housing lower part 13 also contains, of course, charging circuits with charging monitoring electronics for the first batteries and for the second battery, although these are not illustrated in FIG. 3. In the case of the charger 11, for example, they may be arranged under the holders 18 for the first batteries 17.

In addition, FIG. 3 does not show a charging socket, which is provided on the charger 11, for charging the second battery 19.

Finally, FIG. 4 shows a further structure of the charger 21, whose design differs from that of the charger 11 shown in FIGS. 2 and 3.

As shown in FIG. 4, the charger 21 has a second battery 22 (e.g., rechargeable lithium polymer battery) in a housing cover part 23, and a first battery 24 and a charging circuit 25 (for the first battery 24 and/or the second battery 22) in a housing lower part 26. Together, the housing cover part 23 and the housing lower part 26 form the housing 27, which can be opened by folding the cover part 23 and the lower part 26 with respect to one another, or folding them open. Since the cover part 23 does not extend beyond the area of the lower part 26, in which the first battery 24 is provided, the area of the lower part 26 which contains the first battery 24 in the case of the charger 21 can be opened separately to replace the first battery 24.

### Example

A rechargeable lithium polymer battery (Varta PLF, 3.7 V, 1000 mAh) is installed as a second battery in a charger 11, as is described in FIGS. 2 and 3. Two button cells (R48 nickel metal-hydride battery, Varta, approx. 30 mAh) are used as rechargeable first batteries. One of these button cells can be charged approximately 33 times with the aid of the second battery that is used before the installed second battery need be recharged. This recharging of the second battery is carried out via the installed charging socket for low-voltage power supply units, in which case either a plug-in power supply unit or an adapter for a car battery (for example, a cigarette lighter) can then be connected.

The charger 11 has a height H of about 8 mm, a width B of about 56 mm and a length L of about 76 mm. This check-card format allows the charger to be carried in an advantageous manner, in a mobile form, by a user. It is intended in particular for charging button cells for hearing aids.

1-21. (canceled)

22. A mobile charger comprising a connector that facilitates charging at least one first battery from at least one second battery, wherein the second battery is a secondary battery and the second battery has a higher capacity than the first battery, thus allowing the first battery to be charged more than once.

23. The mobile charger of claim 22, wherein the second battery has a capacity which allows the first battery to be charged at least 10 times.

24. The mobile charger of claim 22, wherein the first battery is a button cell.

25. The mobile charger of claim 22, wherein the first battery is a nickel metal-hydride battery.

26. The mobile charger of claim 22, wherein the second battery is a lithium battery.

27. The mobile charger of claim 22, further comprising a housing in which the at least one first battery and the at least one second battery can jointly be arranged.

28. The mobile charger of claim 27, further comprising separate holders for the at least one first battery and for the at least one second battery in the housing.

29. The mobile charger of claim 27, wherein at least two first batteries and at least one second battery can be arranged in the housing.

30. The mobile charger of claim 27, wherein two first batteries and one second battery can be arranged in the housing.

31. The mobile charger of claim 27, wherein the at least one second battery is installed/fixed in the housing.

32. The mobile charger of claim 22, further comprising at least one charging circuit for selection and/or monitoring of parameters of the charging process of the at least one first battery and/or of the at least one second battery, and the charging circuit having at least one charging monitoring electronic means.

33. The mobile charger of claim 32, further comprising separate charging circuits for the at least one first battery and for the at least one second battery.

34. The mobile charger of claim 32, further comprising at least one dedicated holder in the housing for the at least one charging circuit.

35. The mobile charger of claim 22, further comprising a visual indicator for at least one operating state of the charger.

36. The mobile charger of claim 35, wherein the indicator is a light indicator comprising at least one light-emitting diode (LED).

37. The mobile charger of claim 22, further comprising at least one electrical connection in the form of a socket for charging the at least one second battery.

38. The mobile charger of claim 22, wherein the charger has dimensions such that the height of the charger is less than its length and width.

39. The mobile charger as claimed in claim 38, wherein the charger has dimensions substantially similar to a check card.

40. The mobile charger of claim 27, wherein the housing is formed from a trough-like lower part and a cover part.

41. The mobile charger of claim 40, wherein the cover part can be moved with respect to the lower part to open the charger.

42. A method for charging at least one first battery from at least one second battery, comprising connecting the second battery to the first battery with a secondary battery being used as the second battery to charge the at least one first battery, which secondary battery has a higher capacity than the first battery such that the first battery can be charged more than once.
